(19) United States
(12) Patent Application Publication
(10) Pub. No.: US 2013/0106004 A1
(43) Pub. Date: May 2, 2013

(54) HUMIDIFIER ASSEMBLY

(71) Applicant: William C. Stumphauzer, Avon, OH (US)

(72) Inventor: William C. Stumphauzer, Avon, OH (US)

(21) Appl. No.: 13/664,099

(22) Filed: Oct. 30, 2012

Related U.S. Application Data
(60) Provisional application No. 61/554,116, filed on Nov. 1, 2011.

(51) Int. Cl. F24F 3/14; B23P 6/00

(52) U.S. Cl. 261/128; 261/127; 261/129; 29/402.08

(57) ABSTRACT

A humidifier assembly for connection to a supply plenum duct of a forced-air HVAC system through which an air flow passes when a blower associated with the forced-air HVAC system is in operation. The humidifier assembly includes an air-permeable water-saturable media member having a supply air intake side and an opposing humidified air exhaust side, and a housing adapted to hold the media member within the supply plenum duct such that the media member divides the air flow into a first portion that passes alongside the supply air intake side of the media member and a second portion that passes alongside the humidified air exhaust side of the media member.

### BACKGROUND OF INVENTION

1. Field of Invention

The present invention relates to a humidifier assembly. More particularly, the present invention provides an assembly that is capable of humidifying air flowing upwardly through a duct in a forced-air central heating-ventilating-air conditioning (“HVAC”) system.

2. Description of Related Art

Forced air central heating-ventilating-air conditioning (“HVAC”) systems utilize air as a means of heat transfer. Such systems employ ductwork, vents, and plenums to distribute air. A return plenum conveys air from return vents to a central air handler for reheating. A supply plenum conveys air from the central heating unit to rooms that are to be heated by the system. Air handlers in HVAC systems typically also include air filters, one or more blowers, a heat exchanger/element/coil and various controls for controlling the operation of the HVAC system.

Air humidifiers are frequently utilized to add water vapor (humidity) to air for various reasons including the protection of wooden objects, antiques and other furnishings that can be damaged due to overly dry air, and also because as humidity increases, occupants of buildings with forced-air HVAC systems feel warmer at lower temperatures, which results in energy savings due to the use of lower temperature settings.

Humidifiers can be free standing, but are more commonly installed as part of the forced air central HVAC system. A variety of forced-air (also known as “whole house”) humidifiers are known, including:
drum style humidifiers, which typically utilize a fan operated by an electric motor to drive heated air into a drum on which a foam pad is mounted. The foam pad wicks water from a reservoir (pan) as the drum is rotated. The hot air forced into the drum by the fan flows through the water-saturated foam pad to humidify the air.
disc wheel humidifiers, which are similar in many respects to drum style humidifiers, but utilize a plurality of rotating plastic discs with small grooves on both sides instead of a drum and foam pad.
bypass flow-through humidifiers, which are typically mounted externally to the ducting of the supply plenum. Water is dripped onto an expanded aluminum pad. Air from the supply plenum is diverted from and forced through the pad using a blower or other means. Hot air passing through the pad evaporates some of the water and is returned to the ducting of the supply plenum.
spray mist humidifiers, which typically consist of plastic tubes that spray a mist of water directly into the supply air within the supply plenum.

Each of the foregoing styles or types of forced-air humidifiers has disadvantages, such as the need for electrical power to operate fans or evaporator drive assemblies, cleaning and clogging problems and external space requirements. A forced-air humidifier assembly that uses less energy and takes up less space while providing efficient humidity control is needed.

### BRIEF SUMMARY OF THE INVENTION

In view of the foregoing, the present invention provides a humidifier assembly for connection to a supply plenum duct of a forced-air HVAC system through which an air flow passes when a blower associated with the forced-air HVAC system is in operation. The humidifier assembly comprises an air-permeable water-saturable media member having a supply air intake side and an opposing humidified air exhaust side. The media member is held by housing within the supply plenum duct such that the media member divides the air flow into a first portion that passes alongside the supply air intake side of the media member and a second portion that passes alongside the humidified air exhaust side of the media member when the blower associated with the forced-air HVAC system is in operation. A first side of the housing is provided with at least one louvered opening with a slat oriented to direct some but not all of the first portion of the air flow toward the supply air intake side of the media member when the blower associated with the forced-air HVAC system is in operation. More preferably, the first side of the housing is provided with a plurality of louvered openings and slats that perform this function. In a preferred embodiment of the invention, a second side of the housing is provided with at least one louvered opening with a slat oriented to direct the second portion of the air flow away from the humidified air exhaust side of the media member when the blower associated with the forced-air HVAC system is in operation. Again, more preferably, the second side of the housing is provided with a plurality of louvered openings and slats that perform this function. Air directed toward the supply air intake side of the media member creates a zone of positive pressure and air flowing past the humidified air exhaust side of the media member creates a zone of negative pressure, which serves to draw air through the water saturated media member, where it becomes humidified and flows into the supply plenum duct and to the rooms served thereby.

A humidifier assembly according to the invention eliminates the need for electricity to power a motor fan assembly such as is typically employed to move air through a humidifying water panel in conventional humidifier assemblies. It further eliminates the need for an externally mounted, molded-plastic housing thereby drastically reducing the use of hydrocarbon-based thermoplastic polymers. Furthermore, since a humidifier assembly according to the invention is mounted substantially within the supply plenum duct, it does not occupy substantial external space and thus may be used in closet-mounted furnaces or in ducting in space confined areas.

In addition to humidifying air, a humidifier assembly according to the invention can be used for evaporative cooling in dryer climates, which eliminates and/or reduces the need for compressors and condensers resulting in very significant energy savings. Since water is the evaporative medium, environmentally hazardous CFC's are also not needed.

A humidifier assembly according to the invention delivers a desired level of humidity much faster than fan-driven humidifiers because the air flow volume through the media member is much greater. Therefore, the rate of water evaporation is higher.

Humidifier assemblies according to the invention also inhibit the build-up of mold and bacteria in the media member and associated distribution trays and drain trays because the media member is substantially dried by the flow of duct air when there is no water flowing into the media member after the desired level of humidity has been obtained. Humidifiers that obtain air flow with an electric motor fan assembly turn off the flow of air once the desired humidity level is achieved, leaving the media water saturated, where it can grow mold and bacteria. The humidifier assembly according to the invention continually dries and cleans the media member during use and after the desired humidity level has been achieved.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a perspective view of a preferred embodiment of a humidifier assembly according to the invention.

FIG. 2 is a schematic representation of a forced-air HVAC system in which a humidifier assembly as shown in FIG. 1 has been installed.

FIG. 3 is a schematic representation of a humidifier assembly according to claim 1 installed within a supply plenum duct.

FIG. 4 is an exploded perspective view of the humidifier assembly shown in FIG. 1.

FIG. 5 is an exploded perspective view of the housing sub-assembly of the humidifier shown in FIG. 1.

FIG. 6 is an exploded perspective view of a rear side of the housing sub-assembly of the humidifier shown in FIG. 5.

FIG. 7 is an exploded perspective view of the media cartridge sub-assembly of the humidifier shown in FIG. 1.

FIG. 8 is an exploded view of the water supply sub-assembly as shown in FIG. 1.

### DETAILED DESCRIPTION OF THE INVENTION

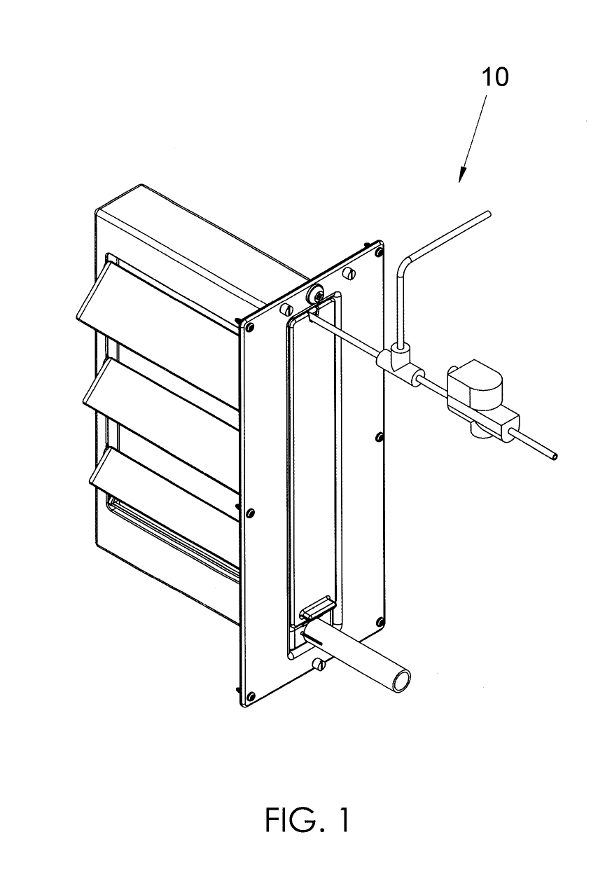

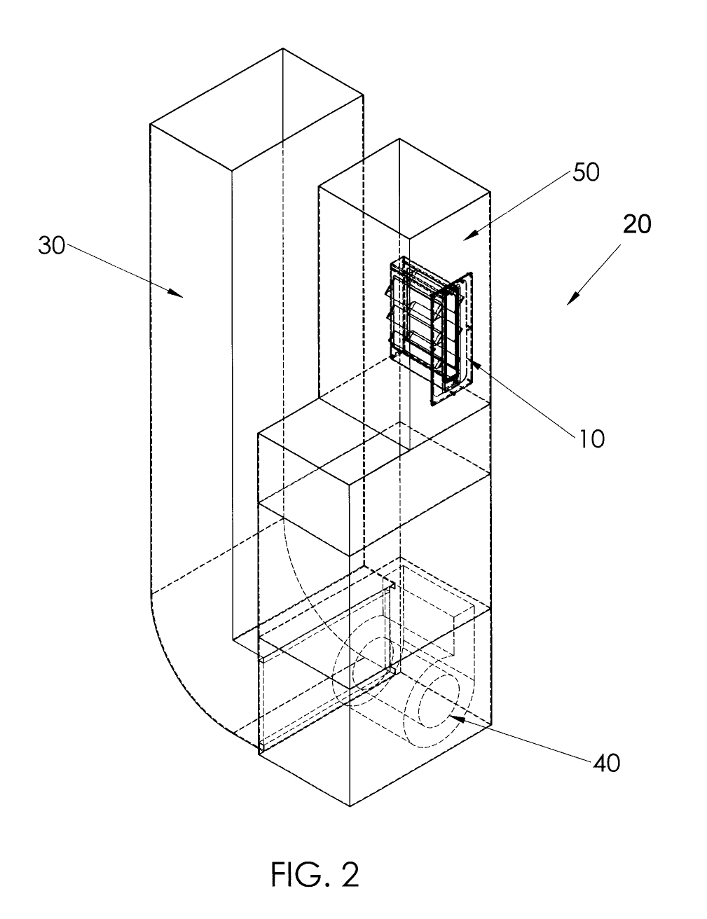

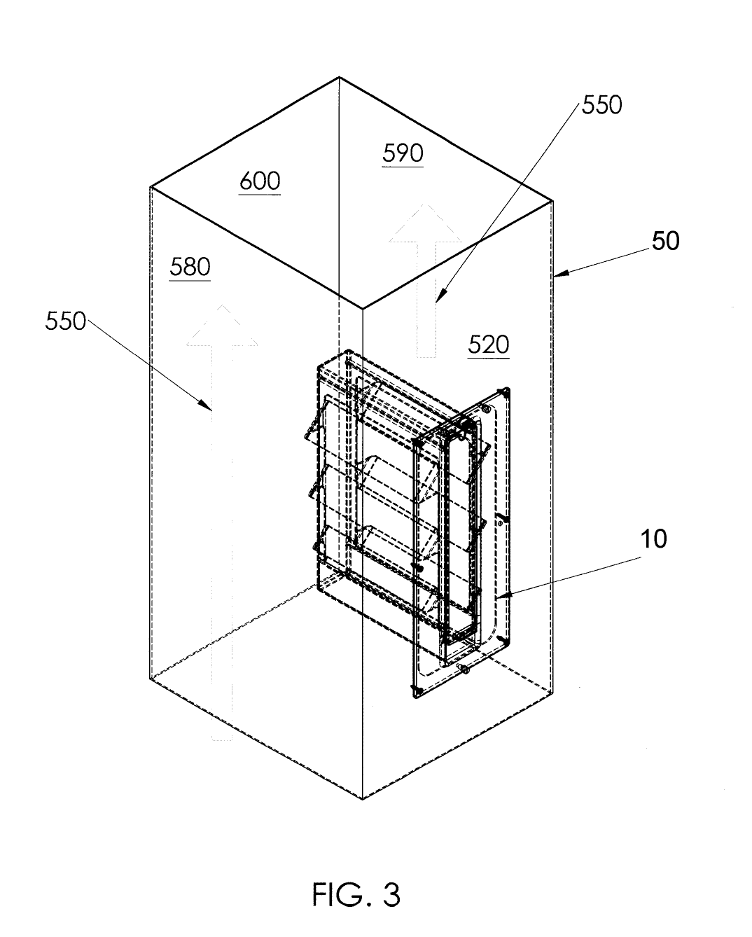

FIG. 1 shows an exemplary embodiment of a humidifier assembly 10 according to the invention in a fully assembled state. FIG. 2 schematically depicts the humidifier assembly 10 of claim 1 installed in a forced-air HVAC system 20, which includes return plenum ducting 30, an associated blower 40 and supply plenum ducting 50. Air, typically from floor vents, is conveyed through the return plenum ducting 30 to the forced-air HVAC system 20, where it is heated and moved by the blower 40 into the supply plenum ducting 50 for distribution to rooms served by the forced-air HVAC system. As noted, the humidifier assembly 10 according to the invention is installed in the supply plenum ducting 50. FIG. 3 provides an enlarged view of a portion of the supply plenum ducting 50 and the humidifier assembly 10 according to the invention.

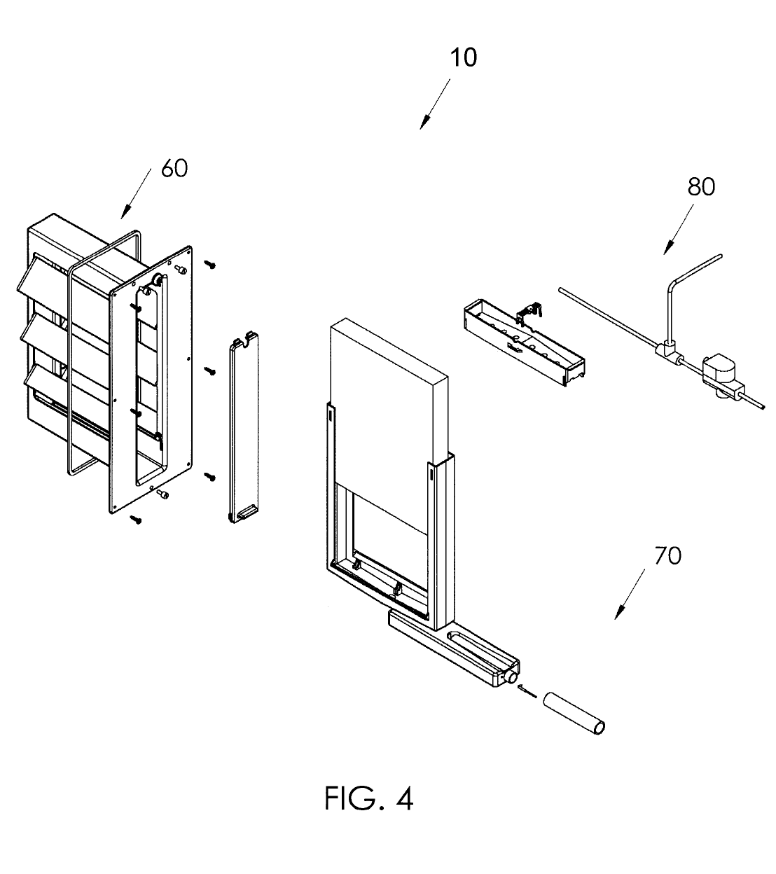

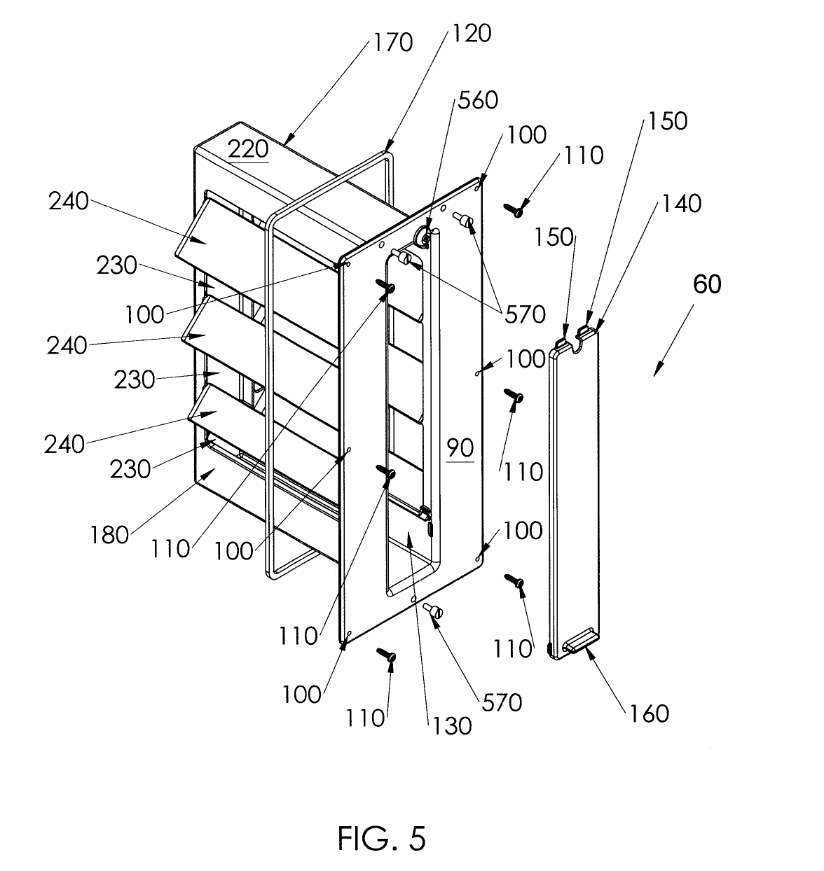

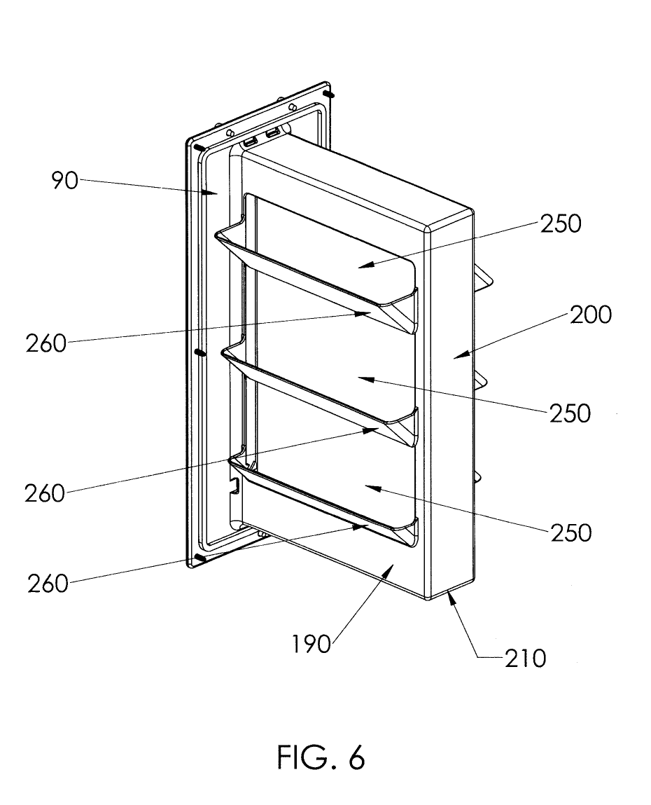

With reference to FIG. 4, the humidifier assembly 10 includes a housing sub-assembly 60, a media member sub-assembly 70 and a water supply sub-assembly 80. FIGS. 5 and 6 show exploded perspective views of the front and rear of the housing sub-assembly 60. The housing sub-assembly 60 includes a mounting flange 90 provided with screw holes 100 through which screws 110 can pass to secure the mounting flange 90 to the supply plenum duct 50. The housing sub-assembly 60 also preferably includes a gasket 120, which helps ensure a substantially air-tight seal between the mounting flange 90 and the supply plenum duct 50.

An opening 130 is provided in the housing. The opening 130 is covered by a door 140, which can be selectively displaced from a closed position, which seals the opening 130, and an open position, in which the opening 130 is not sealed. In the illustrated embodiment, the door 140 is removable, and includes tabs 150 and a handle 160, which allow the door 140 to be selectively secured to and removed from the opening 130.

A housing body 170 extends rearward of the mounting flange 90 and aligns with the opening 130 so as to define a receptacle for the media member sub-assembly 70. The housing body 170 includes a first side 180 and a second side 190. The housing body 170 also preferably includes a closed rear side 200, a closed bottom side 210 and a closed top side 220.

The first side 180 of the housing body 170 is provided with at least one louvered opening 230 with an air-directing slat 240. More preferably, the first side 180 is provided with a plurality of louvered openings 230 and a plurality of associated air-directing slats 240. In the illustrated embodiment, the first side 180 is provided with three louvered openings 230 and three slats 240.

Preferably, the second side 190 of then housing body 170 is also provided with at least one louvered opening 250 with an air-directing slat 260. More preferably, the second side 190 is provided with a plurality of louvered openings 250 and a plurality of associated air-directing slats 260. In the illustrated embodiment, the second side 190 is provided with three louvered openings 250 and three slats 260.

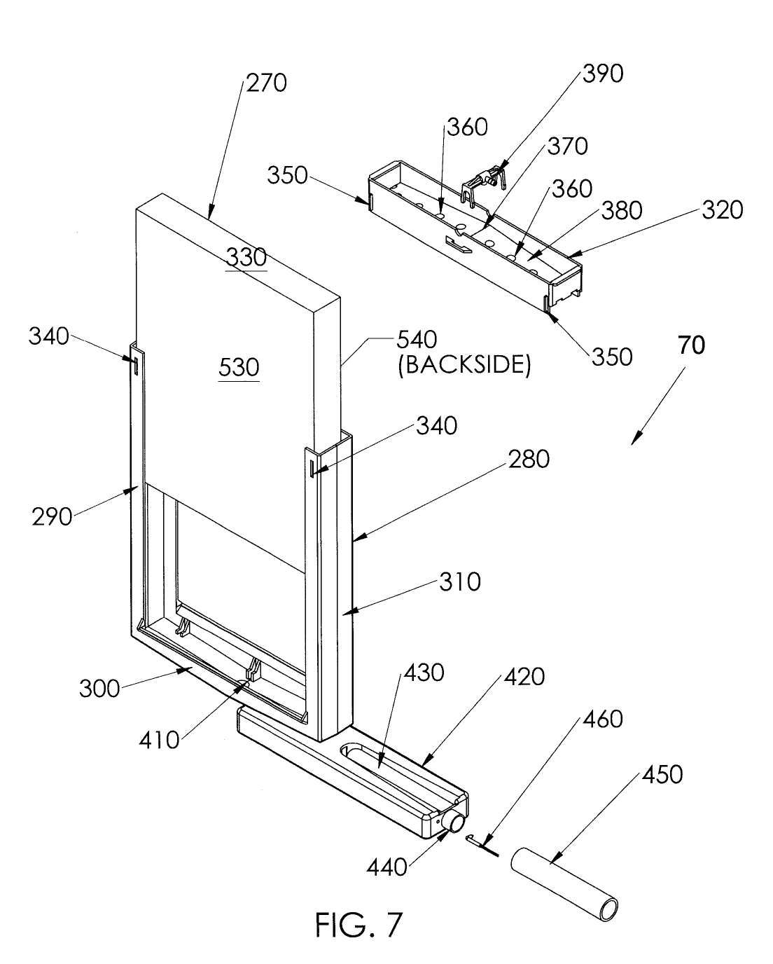

FIG. 7 shows an exploded perspective view of a media member sub-assembly 70, which includes an air-permeable water-saturable media member 270, which is preferably retained by a frame assembly 280. The media member 270 can be made of any air-permeable water-saturable material. Suitable materials include pads made of similarly sized layers of thin expanded aluminum sheets that have been perforated, stacked and bonded together to form an air permeable pad structure. Synthetic materials with mesh outer layers could also be used. The size and thickness of the media member can be varied depending upon the particular installation.

The frame assembly 280 includes a rear frame member 290, a bottom frame member 300 and a front frame member 310, which cooperate to surround corresponding rear, bottom and front perimeter edges of the media member 270. A water distribution tray 320 is disposed above a top perimeter edge 330 the media member 270, and preferably engages with the rear frame member 290 and the front frame member 310 to fully surround the perimeter of the media member 270. Engagement of the water distribution tray 320 with the rear frame member 290 and the front frame member 310 can be achieved through the use of slots 340 and pins 350, as illustrated in FIG. 7.

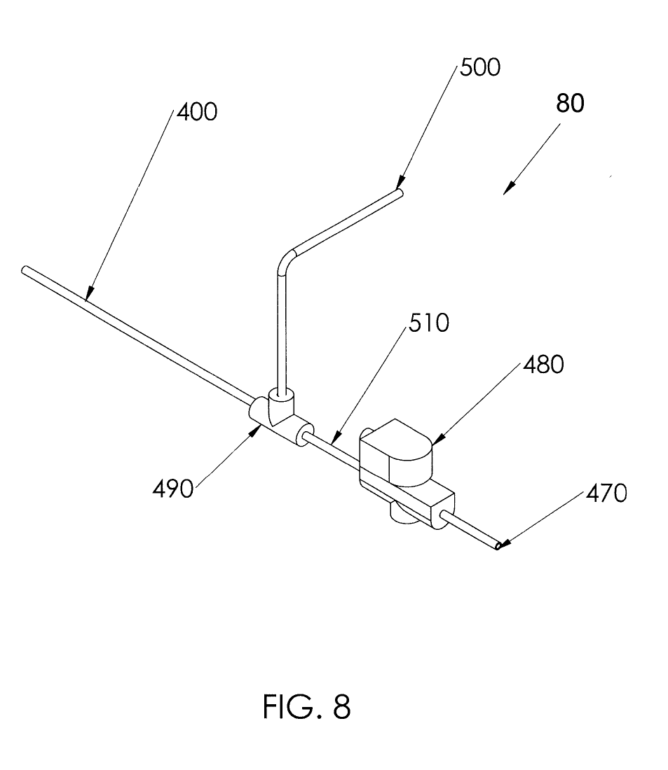

The water distribution tray 320 includes a plurality of holes 360, which are dimensioned and spaced apart so as to be capable of dripping water deposited into the tray onto the top perimeter edge 330 of the media member 270. To help convey water to holes remote from the midline 370 of the water distribution tray 320, the floor 380 of the water distribution tray 320 can be beveled at the midline 370. The water distribution tray 320 is configured to engage with a clip 390, which connects to water inlet tubing 400 (shown in FIG. 8).

A drain hole 410 is provided through the bottom frame member 300 to allow water that passes completely through the media member 270 to exit the frame assembly 280. A drain tray 420 can be positioned beneath the bottom frame member 300. The drain tray 420 includes a channel 430 that leads to an exit port 440. A drain line 450 connects to the exit port 440 to provide a conduit for removing water from the frame assembly 280. A water sensor probe 460 is preferably installed proximal to the exit port 440. The water sensor probe 460 detects whether the exit port 440 and/or the drain line 450 downstream thereof is plugged, and conveys information relating to the condition of the drain system to electronic control logic (not shown).

FIG. 8 shows the water supply sub-assembly 80, which includes the water inlet tubing 400 that engages with the clip 390, as previously described. The water inlet tubing includes an outlet through which water flows into the water distribution tray 320. The water supply sub-assembly 80 includes a water supply line 470, which is connected to a water source such as the household plumbing system. The water supply line 470 is in fluid communication with a solenoid valve 480 that controls the flow of water from the water supply line 470 to the remainder of the water supply sub-assembly 80. The solenoid valve is controlled by electronic control logic (not shown), which adjusts the solenoid valve 480 based on conditions such as the current and desired air humidity, temperature and time. The electronic control logic can be programmed to send a command to the solenoid valve 480 not to permit the flow of water into the water supply sub-assembly 80 if, for example, the water sensor probe 460 detects a plug condition.

Optionally, the water sub-assembly 80 can further comprise a venturi tube 490 or mixing-T that is connected via a conduit 500 to a reservoir (not shown) containing a water additive such as, for example, a fragrance, fungicide and/or mineral dissolving agent. In the event a venturi tube 490 is utilized, an intermediate conduit 510 can be utilized to convey water from the solenoid valve 480 to the venturi tube 490. The water inlet tubing 400 would thereafter convey the water and additive(s) to the water distribution tray 320.

As noted above, the humidifier assembly 10 according to the invention is adapted to be installed in the supply plenum ducting 50 of a forced-air HVAC system. This can be accomplished by forming an opening in a front side 520 of the supply plenum ducting 50 and inserting the housing body 170 of the humidifier assembly 10 into the opening until the mounting flange 90 contacts the front side 520 of the supply plenum ducting 50. The housing body 170 should extend into the supply plenum ducting 50 such that the media member 270 held within the housing divides the air flow within the supply plenum ducting 50 into a first portion that passes alongside a supply air intake side 530 (see FIG. 4) of the media member 270 and a second portion that passes alongside the humidified air exhaust side 540 of the media member 270 when the blower associated with the forced-air HVAC system is in operation. In the embodiment illustrated in FIG. 3, the direction of the air flow is indicated by arrows 550, which show that the air flow is substantially upward. The louvered openings 230 with slats 240 on the first side 180 of the housing 170 are oriented to direct some, but not all, of the first portion of the air flow toward the supply air intake side 530 of the media member 270 when the blower associated with the forced-air HVAC system is in operation. Optionally, but preferably, louvered openings 250 with slats 260 are provided Hon the second side 190 of the housing 170 and are oriented to direct the second portion of the air flow away from the humidified air exhaust side 540 of the media member 270 when the blower associated with the forced-air HVAC system is in operation. The louvered openings 230 with slats 240 on the first side 180 of the housing 170 create a first air pressure on the supply air intake side 530 of the media member 270. The louvered openings 250 with slats 260 on the second side 190 of the housing 170 create a second air pressure on the humidified air exhaust side 540 of the media member 270. The differential between the first air pressure and the second air pressure serves to draw air from the first portion of the air flow through the water saturated media member from the supply air intake side 530 to the humidified air exhaust side 540 when the blower associated with the forced-air HVAC system is in operation. There is a pressure differential between the supply air intake side 530 and the humidified air exhaust side 540 of the media member when the second side of the housing is provided with an basic, flat opening (as opposed to louvered openings 250 with slats 260), but the evaporative efficiency is reduced by about 50%. Accordingly, the use of louvered openings 250 with slats 260 is preferred.

A leveling device 560, preferably a bull's eye spirit level, can be mounted on the housing assembly 60 to assist an installer with orienting the housing such that the media member 270 is oriented in a substantially vertical plane. The installer first orients the housing assembly 60 such that it is oriented vertically within a plane perpendicular to the face of the front side 520 of the supply plenum ducting 50 (i.e., left-right cant angle adjustment). When the vertical alignment has been achieved as indicated using the leveling device 560, screws 110 are inserted through screw holes 100 and loosely anchored into the front side 520 of the supply plenum ducting 50. Leveling screws 570, which bear against but do not penetrate the front side 520 of the supply plenum ducting 50, are then adjusted until the media member 270 is oriented substantially vertically within a plane parallel to the face of the front side 520 of the supply plenum ducting 50 (i.e., forward-reward tilt angle adjustment). Once the vertical adjustments have been made, screws 110 are fully anchored into the front side 520 of the supply plenum ducting 50. The gasket 120 preferably provides sufficient compressibility and bias to allow for minor verticality adjustments. Orientation of the housing member and thus the media member contained within vertically helps ensure that water dripping from the water distribution tray is evenly distributed on the top perimeter edge of the media member and thus the entire media member by the force of gravity.

As shown in FIG. 3, there are gaps or spaces between the first and second sides 180, 190 of the housing 170 and the first and second sides 580, 590 of the supply plenum ducting 50. Optionally, a gap or space can exist between a rear side 200 of the housing 170 and a rear side 600 of the supply plenum ducting 50, or the rear side 200 of the housing 170 can be positioned in contact with the rear side 600 of the supply plenum ducting 50.

In the illustrated embodiment, the air flow is substantially upward. It will be appreciated that the humidifier assembly according to the invention can also function in supply plenum ducting that conveys air in a substantially downward air flow. In such an instance, air would be directed against the supply air intake side of the media member by the louvered openings and slats, and air would be directed away from the humidified exhaust air side of the media member by the louvered openings and slats. Similarly, the humidifier assembly according to the invention could also function in supply plenum ducting that conveys air in a substantially horizontal or otherwise lateral flow. In such an instance, the louvered openings and slats would be oriented substantially perpendicular to the air flow (e.g., substantially vertically for a substantially horizontal air flow). In view of function and ease of servicing, it is preferred that the humidifier assembly be installed in supply plenum ducting that conveys an upward air flow.

While in the illustrated embodiment a supply plenum having a rectangular cross-section is depicted, it will be appreciated that the humidifier assembly according to the invention can be installed in supply plenum ducting having a round or oval cross-section. All that is required is that the housing body and media member be disposed so as to part the air flow through the supply plenum ducting as previously described.

It will also be appreciated that the location of the humidifier assembly is not per se critical. In most instances, it will be installed proximal to the forced-air HVAC system components (e.g., within a run near the blower). But it could also be installed remotely. All that is required is a water source, a drain, and suitable supply plenum ducting.

Over time, it may be necessary to replace a media member in a humidifier assembly according to the invention. To do so, one must merely displace the door of the housing from the closed position to the open position, withdraw the media member (typically including the frame and attached water supply components), install a replacement media member and reposition the door of the housing back to the closed position. To facilitate such changes, the water supply components preferably include sufficient slack or comprise flexible tubing, which allows for withdrawal of the water supply components with the media member and framing. Alternatively, the water supply components can be fixed to the housing such that all that needs to be withdrawn from the housing is the media member itself.

As previously noted above, a humidifier assembly according to the invention eliminates the need for electricity to power a motor fan assembly such as is typically employed to move air through a humidifying water panel in conventional humidifier assemblies. It further eliminates the need for an externally mounted, molded-plastic housing thereby drastically reducing the use of hydrocarbon-based thermoplastic polymers. Furthermore, since a humidifier assembly according to the invention is mounted substantially within the supply plenum duct, it does not occupy substantial external space and thus may be used in closet-mounted furnaces or in ducting in space confined areas.

In addition to humidifying air, a humidifier assembly according to the invention can be used for evaporative cooling in dryer climates, which eliminates and/or reduces the need for compressors and condensers resulting in very significant energy savings. Since water is the evaporative medium, environmentally hazardous CFC's are also not needed.

A humidifier assembly according to the invention delivers a desired level of humidity much faster than fan-driven humidifiers because the air flow volume through the media member is much greater. Therefore, the rate of water evaporation is higher.

Humidifier assemblies according to the invention also inhibit the build-up of mold and bacteria in the media member and associated distribution trays and drain trays because the media member is substantially dried by the flow of duct air when there is no water flowing into the media member after the desired level of humidity has been obtained. Humidifiers that obtain air flow with an electric motor fan assembly turn off the flow of air once the desired humidity level is achieved, leaving the media water saturated, where it can grow mold and bacteria. The humidifier assembly according to the invention continually dries and cleans the media member during use and after the desired humidity level has been achieved.

The following example is intended only to illustrate the invention and should not be construed as imposing limitations upon the claims.

### EXAMPLE

A humidifier assembly as depicted in the accompanying drawing figures was installed in the supply plenum ducting of a forced-air HVAC system such that the media member was vertical. The supply plenum ducting had a cross-sectional diameter of 14″×20″, with the 20″ side facing forward. The mounting flange of the housing body measured 7.90″ wide by 18.66″ high. The opening cut into the supply plenum ducting measured 6.5″ wide by 16.5″ high. The slats on the both sides of the housing body were angled 45° relative to vertical, and extended to a point that was 1.77″ from the louvered openings in both sides of the housing body. The slats were 9.70″ long. The housing body had a width of 2.75″ between the two sides, and received a frame for the media member that was 2.5″ in thickness. The media member itself was 12.71″ high by 10.5″ wide, and had a thickness of 1.93″. It was formed of layers of thin expanded aluminum sheets that were perforated, stacked and bonded together to form an air permeable pad structure. A measurement of the air flow before installation of the humidifier assembly indicated that the blower was supplying an air flow through the plenum at 1,290 CFM. After installation of the humidifier assembly, the air flow around the humidifier assembly increased slightly (It was calculated to be 1500 CFM based on a 14″×20″ opening, which was partially obstructed by the humidifier assembly). The air temperature within the supply plenum ducting at the time of testing was measured to be 118° F. and had a beginning relatively humidity of 44%.

Water was supplied to the media member until it was saturated. Thereafter, measurements were made over the separate hour-long test periods. The evaporation rate measured during the tests is set forth in Table 1 below:

TABLE 1

| | Ounces Per 5 Minutes | Ounces Per Hour | Gallons Per Hour |
|---|---|---|---|
| Test 1 | 8 | 96 | 0.75 |
| Test 2 | 8 | 96 | 0.75 |
| Test 3 | 7 | 84 | 0.66 |
| Average | 7.67 | 92 | 0.72 |

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A humidifier assembly for connection to a supply plenum duct of a forced-air HVAC system through which an air flow passes when a blower associated with the forced-air HVAC system is in operation, the humidifier assembly comprising:
an air-permeable water-saturable media member having a supply air intake side and an opposing humidified air exhaust side; and
a housing adapted to hold the media member within the supply plenum duct such that the media member divides the air flow into a first portion that passes alongside the supply air intake side of the media member and a second portion that passes alongside the humidified air exhaust side of the media member when the blower associated with the forced-air HVAC system is in operation;
wherein a first side of the housing is provided with at least one louvered opening with a slat oriented to direct some but not all of the first portion of the air flow toward the supply air intake side of the media member when the blower associated with the forced-air HVAC system is in operation.

2. The humidifier assembly according to claim 1 wherein a second side of the housing is provided with at least one louvered opening with a slat oriented to direct the second portion of the air flow away from the humidified air exhaust side of the media member when the blower associated with the forced-air HVAC system is in operation.

3. The humidifier assembly according to claim 1 wherein the first side of the housing is provided with a plurality of louvered openings with slats oriented to direct some but not all of the first portion of the air flow toward the supply air intake side of the media member when the blower associated with the forced-air HVAC system is in operation.

4. The humidifier assembly according to claim 3 wherein a second side of the housing is provided with a plurality of louvered openings with slats oriented to direct the second portion of the air flow away from the humidified air exhaust side of the media member when the blower associated with the forced-air HVAC system is in operation.

5. The humidifier assembly according to claim 2 wherein a left perimeter edge, right perimeter edge and bottom perimeter edge of the media member are retained within a frame that slidingly engages with the housing.

6. The humidifier assembly according to claim 5 wherein the frame further comprises a water distribution tray with openings that permit water in the tray to flow onto a top perimeter edge of the media member and thereby saturate the media member with water.

7. The humidifier assembly according to claim 6 wherein when the blower associated with the forced-air HVAC system is in operation the at least one louvered opening on the first side of the housing creates a first air pressure on the supply air intake side of the media member, the at least one louvered opening on the second side of the housing creates a second air pressure on the humidified air exhaust side of the media member, and a differential between the first air pressure and the second air pressure serves to draw air from the first portion of the air flow through the water saturated media member from the supply air intake side to the humidified air exhaust side.

8. The humidifier assembly according to claim 6 further comprising a water supply assembly comprising:
a water supply conduit having an outlet; and
a clip;
wherein the clip connects the water supply conduit to the water distribution tray such that water flowing from the water supply conduit flows from the outlet into the water distribution tray.

9. The humidifier assembly according to claim 8 wherein the water supply assembly further comprises a solenoid valve that controls water flow through the water supply conduit.

10. The humidifier assembly according to claim 9 wherein the water supply assembly further comprises a venturi tube disposed between the solenoid valve and the outlet of the water supply conduit for adding a fragrance, fungicide and/or mineral dissolving agent to water supplied to the media member.

11. The humidifier assembly according to claim 1 wherein a surface defined by the supply air intake side of the media member is substantially planar.

12. The humidifier assembly according to claim 11 wherein a surface defined by the humidified air exhaust side of the media member is substantially planar, and wherein the surfaces of the supply air intake side of the media member and the humidified air exhaust side of the media member are substantially parallel to each other.

13. The humidifier assembly according to claim 11 wherein the surface defined by the supply air intake side of the media member is disposed in a substantially vertical plane.

14. The humidifier assembly according to claim 1 wherein the housing further comprises a door that can be displaced to allow for removal of the media member from the housing while the housing is connected to the supply plenum duct.

15. The humidifier assembly according to claim 13 wherein the housing further comprises a level indicator gauge for use in orienting the housing such that the media member is disposed in the substantially vertical plane.

16. The humidifier assembly according to claim 16 wherein the housing further comprises leveling adjustment screws for use in orienting the housing such that the media member is disposed in the substantially vertical plane.

17. The humidifier assembly according to claim 5 further comprising a drain tray disposed beneath the frame for receiving water draining from the media member and a conduit for conveying water collected in the drain tray away from the humidifier assembly.

18. The humidifier assembly according to claim 9 further comprising a controller for controlling operation of the solenoid valve based on sensed humidity conditions and/or operating conditions of the forced-air HVAC system.

19. A method comprising:
providing a humidifier assembly comprising
an air-permeable water-saturable media member having a supply air intake side and an opposing humidified air exhaust side, and
a housing adapted to hold the media member; and
connecting the housing to a supply plenum duct of a forced-air HVAC system through which an air flow passes when a blower associated with the forced-air HVAC system is in operation;
wherein the housing is connected to the supply plenum such that the housing holds the media member within the supply plenum duct such that the media member divides the air flow into a first portion that passes alongside the supply air intake side of the media member and a second portion that passes alongside the humidified air exhaust side of the media member when the blower associated with the forced-air HVAC system is in operation; and
wherein a first side of the housing is provided with at least one louvered opening with a slat oriented to direct some but not all of the first portion of the air flow toward the supply air intake side of the media member when the blower associated with the forced-air HVAC system is in operation.

20. A method for servicing a humidifier assembly connected to a forced-air HVAC system according to claim 19, the method comprising:
displacing a door associated with the housing that allows access to the media member held therein from a closed position to an open position;
removing the media member from the housing while the housing is connected to the supply plenum duct;
installing a replacement media member within the housing; and
returning the door associated with the housing from the open position to the closed position.
